(19) United States
(12) Patent Application Publication
(10) Pub. No.: US 2011/0256780 A1
(43) Pub. Date: Oct. 20, 2011

(54) CONTACT-CARRIER COMBINATION FOR ELECTRICAL CONNECTOR

(75) Inventor: JIAN-MIN PENG, Guangzhou (CN)

(73) Assignee: LOTES CO., LTD., Keelung City (TW)

(21) Appl. No.: 13/074,151

(22) Filed: Mar. 29, 2011

(30) Foreign Application Priority Data
Apr. 20, 2010 (CN) 201010155598.3

(51) Int. Cl. H01R 24/00; H01R 13/02

(52) U.S. Cl. 439/676; 439/885

(57) ABSTRACT

The instant disclosure provides a contact-carrier combination for an electrical connector. The contact-carrier combination includes a carrier having a palm portion and a plurality of finger portions extending from the palm portion and laterally separated from each other at a predetermined interval, and a plurality of contacts correspondingly connected to the plurality of finger portions. Each finger portion is bent to form an escaping section. Each contact includes a base portion detachably connected to the carrier and a flexible arm slantingly extending from the base portion in a direction substantially the same as the bending direction of the receiving arm. The additional room provided by the arrangement of the instant disclosure enables the connector to adapt longer flexible arms, thereby enhancing the overall electrical connectivity of the connector and reduce assembly complexity. With the simplified shape of the contact in a completed connector, dimensional accuracy can be easily maintained.

### BACKGROUND OF THE INVENTION

1. Field of the Invention

The present invention relates to a combination of an electrical contact units and carrier thereof, and pertains particularly to an electrical contact-carrier combination for electrical connectors to establish connection between a chipset module and a circuit board.

2. Description of Related Art

As the physical dimension of modern computers shrinks, smaller and more sophisticated electrical connectors are required. An electrical connector usually includes an insulating housing having a plurality of contact receiving slots for hosting a plurality of electrical contacts. To achieve high contact density within a limited space, the receiving slots of the insulating housing are disposed as tight as possible. Conventionally, high contact density is achieved by arranging receiving slots in aligned rows and columns in a manner similar to a matrix. However, although the matrix arrangement of the contacts enables the highest distribution density on a rectangular insulating housing, such configuration requires the use of contacts having shorter contact arms to maintain adequate distance from the neighboring contacts and thus prevent potential short-circuit problems. As a result, the conducting performance of the conventional connector will suffer due to short flexible arms.

Attempts are already made to address the above problems. For example, China patent CN02292491.4 discloses a contact of the electrical connector for electrically connecting an electrical element to a circuit board, and is hereby incorporated by reference. The connector includes a base and a plurality of contacts made from sheet metal by stamping methods. The base has a plurality of contact receiving slots, and each contact is received in a contact receiving slot. Each contact includes a connecting portion inserted in the contact receiving slot, a vertical body bent from the connecting portion, and a flexible arm (the flexible arm includes a bent portion and a cantilever arm) extended upwards from the vertical arm. The connecting portion is bent 90 degrees to form a vertical body. The flexible arm is formed at the end of the vertical body through a first bending line. The first bending line constitutes a specific angle with respect to the horizontal plane. The extending direction of the flexible arm and the horizontal plane also form a specific angle, and the flexible arm extends forwards and away from the vertical body.

The assembly method for the electrical connector of the incorporated reference is also described below. A base having a plurality of contact receiving slots arranged thereon is provided. Specifically, the contact receiving slots are arranged parallel to the side of the base. Then, a plurality of contact-carrier combinations are provided. Each contact-carrier combination has a plurality of contacts connected thereto. The contact-carrier combinations are then installed into the rows of contact receiving slots. Specifically, the carriers are configured in a fashion parallel to one side of the base. The carriers exposing outside of the base are then removed. The manufacturing of the referenced electrical connector is then complete.

Although the reference connector achieves a higher contact density and provides more flexible contact arms, it still has the following drawbacks:

1. The vertical body is bent from the connecting portion, and the flexible arm is further formed from the vertical body with the first bending and second bending. As a result, there is a very complicated 3-dimensional angular and dimensional relation between the connecting portion which is inserted in the receiving slots, and the flexible arm which is to match its connecting chip component. Possible manufacturing variation to this complex shape may occur during the bending process. The accumulated dimensional or angular variations may result in misalignment between the complex shaped contact and the chip component. Variations from the bending process cause misalignment between the contacts and electrical elements, resulting in poor electrical connection.

2. The vertical body is bent from the connecting portion, and the flexible arm is further bent from the vertical body in different directions by the first bending and the second bending. As a result, there is a complex 3-dimensional angular and dimensional relationship between the connecting portion and the flexible arm. Manufacturing variation of this complex structure has a high likelihood of occurrence during the bending process. The accumulated variations may result in misalignment between the very complicated contact and the receiving slot. The contacts may be damaged during the installation process due to the misalignment between the contacts and receiving slots, or at least making the installation of the contacts difficult. As a result, the assembly speed of the connector is reduced.

Therefore, there remains a need for an improved contact-carrier combination to address the abovementioned problems.

### SUMMARY OF THE INVENTION

One aspect of the instant disclosure is to provide a contact-carrier combination for an electrical connector. The contact-carrier combination includes a carrier having a palm portion and a plurality of finger portions extending from the palm portion and laterally separated from each other at a predetermined interval, and a plurality of contacts correspondingly connected to the plurality of finger portions. Each finger portion is bent to form an escaping section. Each of the contacts includes a base portion detachably connected to the carrier and a flexible arm slantingly extending from the base portion in a direction substantially the same as the bending direction of the escaping section.

Comparing to the contact arrangement in conventional connectors, contact arrangement of the instant disclosure allows the upper portion of the flexible arm to extend toward the direction of the slanting portion of the finger portion. Thus, when a plurality of the contact-carrier combinations 1 are placed in a staggered configuration in parallel rows, the flexible arm of the contact in a rear row can partially extend into the space defined by the escaping section of the carrier in a front row without interfering with each other. Thus, the additional room provided by the arrangement of the instant disclosure enables the connector to adapt longer flexible arms, thereby enhancing the overall electrical connectivity of the connector. Moreover, unlike the contact of conventional design, which requires a (structurally weakening) 90-degree bending structure to be formed on the vertical body thereof, the instant contact-carrier combination incorporates a bending section on the carrier which is later removed. Therefore, the shape of the contact (in a completed connector) can be simplified and the structural integrity can be retained. Furthermore, with the slanting arrangement of the contact-carrier combination with respect to the side wall of the insulating housing, it is also possible to reduce the complicated 3-dimensional bending arrangement of the prior art into a simpler 2-dimensional setup. As a result, the accumulation of manufacturing variation may be lessened and become less critical in a completed connector. Therefore, the assembling precision may be better maintained.

For further understanding of the present invention, reference is made to the following detailed description illustrating the embodiments and examples of the present invention. The description is for illustrative purpose only and is not intended to limit the scope of the claim.

### BRIEF DESCRIPTION OF THE DRAWINGS

FIG. 1 shows a perspective view of a contact-carrier combination in accordance with the instant disclosure;

FIG. 2 shows a rear view of a contact-carrier combination in accordance with the instant disclosure;

FIG. 3 shows a side view of the a contact-carrier combination in accordance with the instant disclosure;

FIG. 4 shows a perspective view of the insulating housing of an electrical connector in accordance with the instant disclosure;

FIG. 5 shows a schematic diagram of a contact-carrier combination being installed into the receiving slots in a front row of the insulating housing of an electrical connector in accordance with the instant disclosure;

FIG. 6 shows a schematic diagram of another contact-carrier combination being installed into the receiving slots in a rear row of the insulating housing of an electrical connector in accordance with the instant disclosure;

FIG. 7 shows a schematic diagram of the contact-carrier combinations being assembled into the insulating housing in accordance with the instant disclosure;

FIG. 8 shows a schematic diagram of the contact-carrier combination being assembled into the insulating housing in accordance with the instant disclosure from a different angle; and

FIG. 9 shows a schematic diagram of the contacts in accordance with the instant disclosure being installed into the insulating housing and the carrier being removed.

### DETAILED DESCRIPTION OF THE PREFERRED EMBODIMENTS

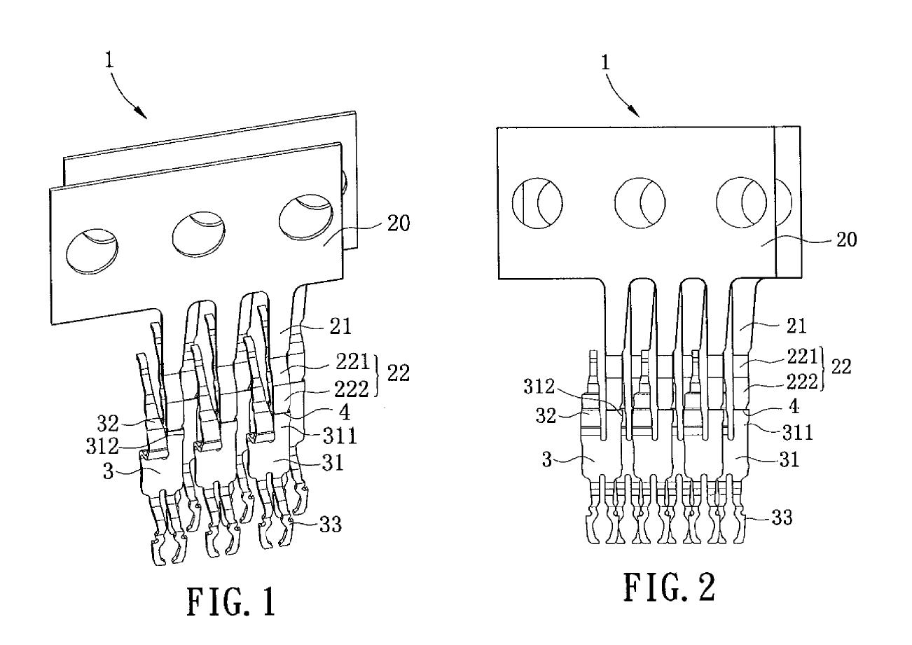

Please refer to FIGS. 1 to 3, which show schematic diagrams of the contact-carrier combination in accordance with the instant disclosure. For illustration clarity, only two contact-carrier combinations are shown in the instant figures.

Each contact-carrier combination 1 comprises a carrier, which has a palm portion 20 and a plurality of finger portions 21, and a plurality of contacts 3 detachably connected to the end of the finger portions 21. The contact-carrier combination 1 may be made from sheet metal by methods such as stamping technique. To reduce manufacturing complexity and increase assembling efficiency of the electrical connector, the plurality of contacts 3 attached thereon is preferably of identical physical structure, and a plurality of identical contact-carrier combinations may be correspondingly installed in the receiving slots of a connector. However, contact-carrier combinations of different physical structure may be concurrently used, as long as the finger portion 21 of the carrier of a contact-carrier combination is arranged in a manner that provides sufficient space to avoid interference with the flexible arm 32 of the contact 3 of its neighboring contact-carrier combination.

The plurality of the finger portions 21 of the carrier extend downward from the palm portion 20 and are laterally separated by a predetermined interval. Each finger portion 21 is bent to form an escaping section 22. In other words, the escaping section 22 is bent away from the root of the finger portion 21 at a predetermined slanting angle (first angle). The escaping section 22 includes a slanting first connecting portion 221 and a further bent second connecting portion 222. Specifically, the second connecting portion 222 slantingly extends from the first connecting portion 221 at a predetermined angle (second angle). The instant embodiment shows the arrangement of an obtuse angle between the two connection portions (221, 222). However, right angle or acute angle may be adapted as well. Alternatively, the first and the second connecting portions (221,222) may be coplanar with no bending angle in between.

Each of the contacts 3 includes a base portion 31. A carrier connecting portion 331 is extendedly formed from one side of the upper base portion 31. The carrier connecting portion 331 is correspondingly connected to the second connecting portion 222 of the carrier with a breaking portion 4 arranged in between. The carrier connecting portion 331 further includes a laterally protruding retaining portion 312. In addition, the other side of the upper base portion 31 extends outward from the main surface thereof and then back toward itself to form a flexible arm 32. Preferably, the flexible arm 32 is arranged substantially toward the same direction as the slanting escaping section 22. Thus, the flexible arm 32 and the carrier connecting portion 331 are laterally adjacent to each other on the upper portion of the contact 3. The lower end of the base portion 31 extends downward to form a pair of holding legs 34.

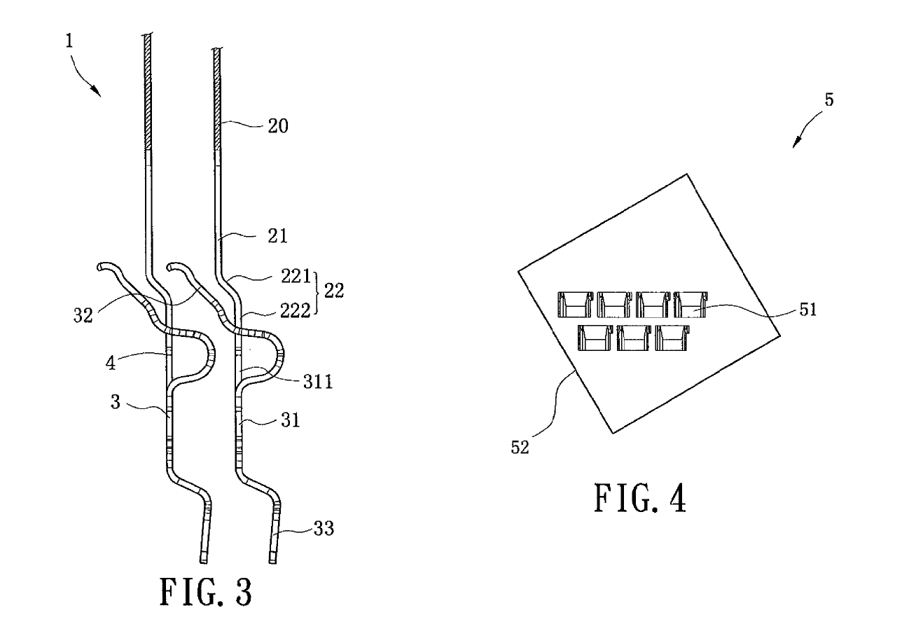

Please refer to FIG. 3, which shows an embodiment in accordance with the instant disclosure. In this specific example, the second connecting portion 222 of the carrier is arranged in a coplanar manner with the base portion 31 and the carrier connecting portion 311 of the contact 3. Moreover, the finger portion 21 of the carrier and the base portion 31 of the contact 3 are parallel to each other.

Please refer to FIGS. 2 and 3. Because the upper portion of the flexible arm 32 extends toward the direction of the slanting second connecting portion 222 of the finger portion 21, when a plurality of the contact-carrier combinations 1 are placed in a staggered configuration in parallel rows (i.e., each of the flexible arms 32 of a front carrier is aligned between two flexible arms from a rear row), the flexible arm of the contact in a rear row can partially (or even fully) extends into the space defined by the escaping section of the carrier in a front row without interference. Thus, the additional room provided by the arrangement of the instant disclosure enables the connector 3 to adapt longer flexible arms, thereby enhancing the overall electrical connectivity of the connector.

Reference is now made to FIG. 4, which shows an insulating housing 5 of a connector. The insulating housing 5 hosts a plurality row of contact receiving slots 51 corresponding designed to receive the contacts 3 of a plurality of the contact-carrier combination 1. However, for illustration simplicity, the instant figure only shows two rows of receiving slots. Specifically, the receiving slots 51 are arranged in a staggered configuration in parallel rows (i.e., one receiving slot 51 in a rear row is located substantially behind and between two receiving slots 51 of an immediate front row). This means that the center line of the receiving slot 51 in a rear row is located between the two receiving slots 51 in an immediate front row. Moreover, the receiving slot 51 is slantingly disposed on the top face of the insulating housing 5 at a predetermined angle with respect to side wall 52. As shown in FIG. 4, the slant angle is preferably 45 degrees.

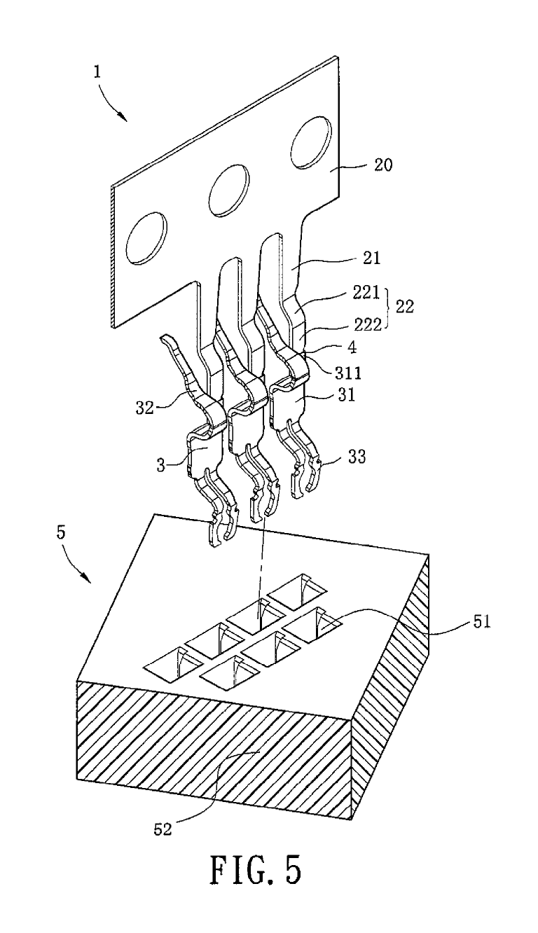

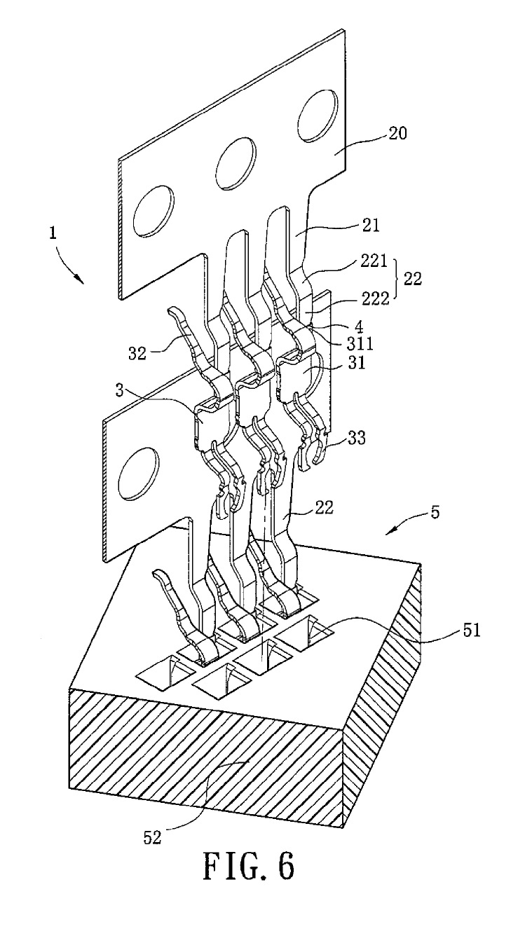

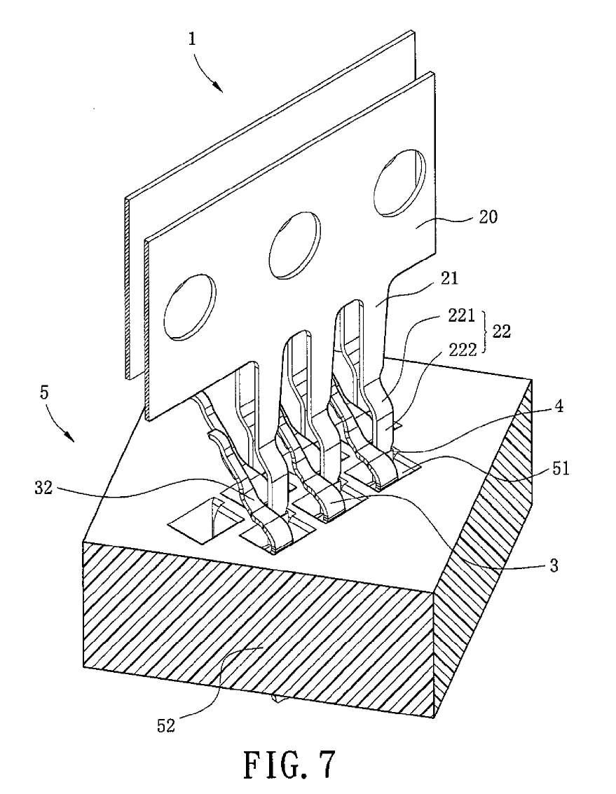

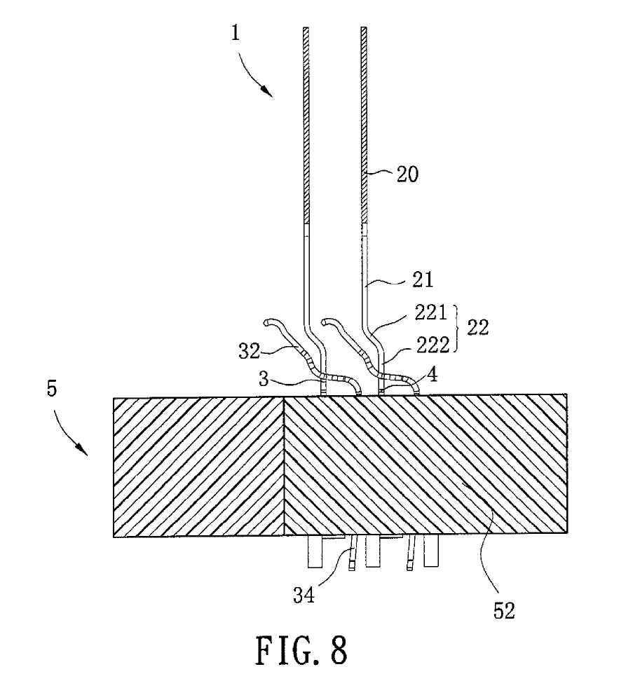

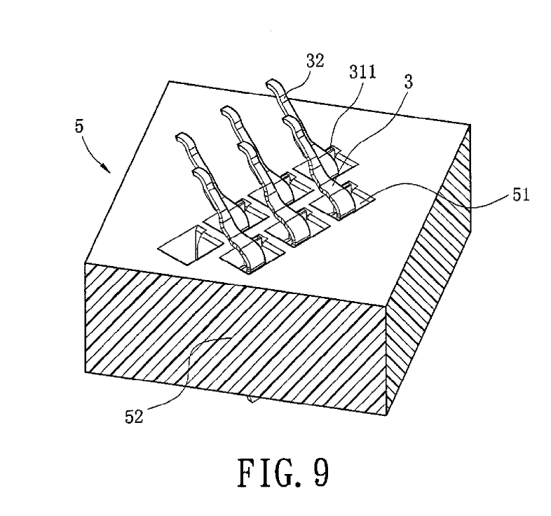

Reference is now made to FIGS. 5 to 9, which show the assembly processes for assembling the contact-carrier combination 1 in the insulating housing 5.

First, the contacts of a first contact-carrier combination 1 in accordance with the instant disclosure are installed into the receiving slots 51 in a front slot row of the insulating housing 5. The base portion 31 of the contacts 3 are fastened in the corresponding receiving slots 51. The carrier 20 is seated on the upper face of the insulating housing 5 at an angle with respect to the side wall 52. The angle is preferably 45 degrees as shown in the instant figures.

Next, the contacts 3 of a second contact-carrier combination 1 are installed into the corresponding receiving slots 51 in a rear row in an identical orientation as the first contact-carrier combination. The base portion 31 of the contacts 3 are fastened in the corresponding receiving slots 51. Thanks to the slanting angle of the escaping section 222 of the finger portion 21, the flexible arm 32 of the contacts 3 from a rear row can partially extend into a space defined by the corresponding escaping sections of the contact-carrier combinations in a front row. Thus, the additional room provided by the arrangement of the instant disclosure enables the connector 3 to adapt longer flexible arms, thereby enhancing the overall electrical connectivity of the connector.

Finally, the exposing palm portion 20 of the carrier above the carrier connecting portion 33 of the contact 3 can be detached along the breaking portion 4.

The installation of the electrical contacts is therefore complete.

The contact-carrier combination and the manufacturing method for an electrical connector with the contacts of the present invention have the following advantageous characteristics.

1. The base portion extends upward to form the flexible arm and the carrier-connecting portion, and the carrier-connecting portion is connected to the carrier, so that the base portion of the contact does not need to be bent to form the carrier-connecting portion when the contact is formed. Therefore, the problem of the contact location of the contact and the electronic element of the prior art being inaccurate to affect the contact between the flexible arm and the electronic element does not exist.

2. Because the base portion extends upwards to form the flexible arm and the carrier-connecting portion, and the carrier-connecting portion is connected with the carrier, the base portion does not need to be bent to form the carrier-connecting portion when the contact is formed. Therefore, the problem of a variation existed between the contact and the receiving slot of prior art does not exist. Further, the problem of difficult assembly or the contact being damaged also does not exist. The installation speed will not be lowered.

3. Because the finger portion is bent to define an accommodating space, and the flexible arm of the contact in the rear row can partially extend into the space of the adjacent finger portion, the flexible arms of longer length may be adapted, thus enhancing the contact performance of the connector.

4. Because the finger portion is bent to define an accommodating space, and the flexible arm of the contact in the rear row can partially extend into the space of the adjacent finger portion, the disposition of the receiving slots of the insulating housing for receiving the contacts can be highly concentrated.

5. Because the space for part of the flexible arm of the contact to extend into is located on the carrier portion of the contact-carrier combination, which is to be removed to form the electrical connector after the contact-carrier combination is assembled with the insulating housing. Therefore, the accuracy of the space formed from bending the finger portion of the carrier is not a key factor. Even though it is not controlled in a highly precise angle, the dimensional accuracy can still be maintained, and the positional accuracy between the contact and the electronic element can also be kept.

6. The angle between the contact-carrier combination and the side wall of the insulating housing is 45 degrees. The slanted structure in the insulating housing can be disposed with the contacts that its quantity is more than prior art. The contacts can be highly concentrated.

The description above only illustrates specific embodiments and examples of the present invention. The present invention should therefore cover various modifications and variations made to the herein-described structure and operations of the present invention, provided they fall within the scope of the present invention as defined in the following appended claims.

What is claimed is:

1. A contact-carrier combination, comprising:
a carrier having a palm portion and a plurality of finger portions extending there-from and laterally separated from each other at an predetermined interval, each finger portion being bent to form an escaping section; and
a plurality of contacts correspondingly and detachably connected to the finger portions, each contact having
a base portion detachably connected to the escaping section of the carrier and
a flexible arm slantingly extending from the base portion, the direction of extension of the flexible arm being substantially the same as the bending direction of the escaping section;
wherein when two contact-carrier combinations are placed in a staggered configuration in parallel rows, the flexible arm of the contact in a rear row at least partially extends into a space defined by the escaping section of the carrier in a front row.

2. The contact-carrier combination as claimed in claim 1, wherein the escaping section has a first connecting portion and a second connecting portion; wherein the first connecting portion includes a slanting portion at an angle.

3. The contact-carrier combination as claimed in claim 2, wherein the angle is a right angle

4. The contact-carrier combination as claimed in claim 2, wherein the angle is an obtuse angle.

5. The co contact-carrier combination as claimed in claim 2, wherein the angle is an acute angle.

6. The contact-carrier combination as claimed in claim 2, wherein the second connecting portion and the base portion are coplanar.

7. The contact-carrier combination as claimed in claim 2, wherein the first connecting portion and the base portion are parallel.

8. The contact-carrier combination as claimed in claim 1, wherein the upper base portion extends backward and then forward to form the flexible arm.

9. The contact-carrier combination as claimed in claim 1, wherein the upper base portion of the contact extends upward to form a carrier connecting portion, the carrier connecting portion being detachably connected to the escaping section of the carrier.

10. The contact-carrier combination as claimed in claim 1, wherein the base portion of the contact extends downward to form a pair of holding legs.

11. The contact-carrier combination as claimed in claim 1, wherein the plurality of contacts connected thereon are identical.

12. An electrical connector comprising a plurality of contact-carrier combinations, wherein each contact-carrier combination comprising:
a carrier having a palm portion and a plurality of finger portions extending there-from and laterally separated from each other at an predetermined interval, each finger portion being bent to form an escaping section; and
a plurality of contacts correspondingly and detachably connected to the finger portions, each contact having
a base portion detachably connected to the escaping section of the carrier and
a flexible arm slantingly extending from the base portion, the direction of extension of the flexible arm being substantially the same as the bending direction of the escaping section;
wherein when two contact-carrier combinations are placed in a staggered configuration in parallel rows, the flexible arm of the contact in a rear row at least partially extends into a space defined by the escaping section of the carrier in a front row;
wherein the carriers are identical.
